(19) United States
(12) Patent Application Publication
(10) Pub. No.: US 2025/0149052 A1
(43) Pub. Date: May 8, 2025

(54) METHOD FOR PROVIDING AN ARTIFICIAL INTELLIGENCE SYSTEM WITH REDUCTION OF BACKGROUND NOISE

(71) Applicant: BitHuman Inc

(72) Inventors: Yun Fu, Newton, MA (US); Steve Gu, Lafayette, CA (US)

(73) Assignee: BitHuman Inc, (omitted)

(21) Appl. No.: 18/387,016

(22) Filed: Nov. 4, 2023

(51) Int. Cl. G10L 21/0208; G06T 13/40; G06V 40/16

(52) U.S. Cl. CPC G10L 21/0208; G06T 13/40; G06V 40/16; G10L 2021/02087

(57) ABSTRACT

Embodiments of the present disclosure may include a method for providing an artificial intelligence system with the ability to reduce impact from background noise within an area, the method including setting a set of goals before conversations with a user.

### BACKGROUND OF THE INVENTION

Embodiments of the present disclosure may include a method for providing an artificial intelligence system with the ability to reduce impact from background noise within an area, the method including setting a set of goals before conversations with a user.

### BRIEF SUMMARY

Embodiments of the present disclosure may include a method for providing an artificial intelligence system with the ability to reduce impact from background noise within an area, the method including setting a set of goals before conversations with a user. In some embodiments, the artificial intelligence system may include an artificial intelligence engine.

In some embodiments, an artificial intelligence engine may be configured to actively drive the conversations. In some embodiments, the set of goals may be related to the conversations. In some embodiments, the conversations may relate to any of processes of sales, meditation, teaching, consulting, training, and mental health treatment.

Embodiments may also include detecting, by one or more processors, the user in proximity with the artificial intelligence. In some embodiments, an artificial intelligence engine in the artificial intelligence system may be coupled to the one or more processors and a server. In some embodiments, the artificial intelligence engine may be trained by human experts in the field.

In some embodiments, a virtual agent may be configured to be displayed in LED/OLED displays, Android/iOS tablets, Laptops/PCs, smartphones, or VR/AR goggles. In some embodiments, a set of multi-layer info panels coupled to the one or more processors may be configured to overlay graphics on top of the virtual agent. In some embodiments, the visual agent may be configured to be displayed with an appearance of a real human or a humanoid or a cartoon character.

In some embodiments, the virtual agent's gender, age and ethnicity may be determined by the artificial Intelligence engine's analysis on input from the user. In some embodiments, the visual agent may be configured to be displayed in full body or half body portrait mode. In some embodiments, the artificial intelligence engine may be configured for real-time speech recognition, speech to text generation, real-time dialog generation, text to speech generation, voice-driven animation, and human avatar generation.

In some embodiments, the artificial intelligence engine may be configured to emulate different voices and use different languages. Embodiments may also include deciding a personality setting at the beginning of the conversation. In some embodiments, the AI engine may be configured to follow the personality setting during the conversation.

Embodiments may also include initiating conversations by stating general greetings for the user if the user may be a new customer or personalized greetings for the user if the user may be a known customer. Embodiments may also include asking a list of questions to the user. In some embodiments, the list of questions may be customized for the user.

Embodiments may also include confirming if the user status may be ready and the user has positive emotion to continue. In some embodiments, the intelligence engine may be configured to switch topics or end the conversation if the user may be not ready. Embodiments may also include detecting and tracking the user's face, eye, and pose by a set of outward-facing cameras coupled to the one or more processors.

In some embodiments, a set of touch screens coupled to the one or more processors may be configured to allow the user to interact with the virtual agent by hand. Embodiments may also include using the set of outward-facing cameras to capture users' status to evaluate engagement. Embodiments may also include and decide the response or trigger topics and contents of the conversations.

Embodiments may also include detecting the user's voice by a set of microphones coupled to the one or more processors. In some embodiments, the set of microphones may be connected to loudspeakers. In some embodiments, the set of microphones may be enabled to be beamforming. In some embodiments, pictures or voices of the user may be configured to be uploaded and processed either on a cloud server or in local or personal devices to analyze and create the virtual agent.

In some embodiments, the visual agent may be configured to be created based on the appearance of a real human character, a popular cartoon character. In some embodiments, the virtual agent may be related to a personality shown in the advertisement of the area. In some embodiments, the artificial intelligence engine may be configured to understand users' status from voice and language.

Embodiments may also include detecting background noise in an environment during the conversation. Embodiments may also include analyzing levels of the background noise in the environment during the conversation. Embodiments may also include recognizing the voice information of the user in the conversation. In some embodiments, the artificial intelligence may be configured to tell the voice information of the user from the background noise by methods of voice re-identification, voice-and-face correlation, voice distance correlation.

In some embodiments, voice-and-face correlation may be based on model fitting of simultaneous emission of facial and vocal expressions. In some embodiments, the artificial may be configured to detect whether the user may be paying attention to the conversation by analyzing the facial and vocal expressions from the user. Embodiments may also include receiving responses from the user.

In some embodiments, the responses may include voice, facial expressions, body language, motion, poses and gestures. Embodiments may also include analyzing the user's status. In some embodiments, the user status may include psychological status, emotion and insights. Embodiments may also include setting a limit for a confidence level of recognition of the voice information of the user in the conversation.

In some embodiments, the confidence level in real-time may be decided by an interactive method. In some embodiments, the continuation of the conversation may be decided by comparing the confidence level in real-time with the limit. Embodiments may also include initiating a question to the user when the confidence level may be lower than the limit.

Embodiments may also include confirming if the artificial intelligence system understands user information correctly. Embodiments may also include apologizing to the user when the artificial intelligence cannot understand user information and asking for the user to repeat the last information from the user. Embodiments may also include changing the confidence level to a higher value and comparing the changed confidence level to the limit.

Embodiments may also include continuing the conversation when the confidence level may be higher than the limit. Embodiments may also include using tree-based or rule-based strategy to decide responses to the responses from the user. Embodiments may also include confirming that the user's status may be aligned with the AI engine's real-time evaluation.

Embodiments may also include checking the completion status of the set of goals in real-time. In some embodiments, if the set of goals may be not reached, the AI engine may be configured to continue the conversations. In some embodiments, if the set of goals may be reached, the AI engine may be configured to suggest to end the conversations. In some embodiments, if the user's responses may be not positively driving, the AI engine may be configured to revise the set of goals during the conversation by mitigating the unsatisfied responses from the user.

Embodiments of the present disclosure may also include a method for providing an artificial intelligence system with ability to reduce impact from background noise within an area, the method including setting a set of goals before conversations with a user. In some embodiments, the artificial intelligence system may include an artificial intelligence engine.

In some embodiments, an artificial intelligence engine may be configured to actively drive the conversations. In some embodiments, the set of goals may be related to the conversations. In some embodiments, the conversations may relate to any of processes of sales, meditation, teaching, consulting, training, and mental health treatment.

Embodiments may also include detecting, by one or more processors, the user in proximity with the artificial intelligence. In some embodiments, an artificial intelligence engine in the artificial intelligence system may be coupled to the one or more processors and a server. In some embodiments, the artificial intelligence engine may be trained by human experts in the field.

In some embodiments, a virtual agent may be configured to be displayed in LED/OLED displays, Android/iOS tablets, Laptops/PCs, smartphones, or VR/AR goggles. In some embodiments, a set of multi-layer info panels coupled to the one or more processors may be configured to overlay graphics on top of the virtual agent. In some embodiments, the visual agent may be configured to be displayed with an appearance of a real human or a humanoid or a cartoon character.

In some embodiments, the virtual agent's gender, age and ethnicity may be determined by the artificial Intelligence engine's analysis on input from the user. Embodiments may also include deciding a personality setting at the beginning of the conversation. In some embodiments, the AI engine may be configured to follow the personality setting during the conversation.

Embodiments may also include initiating conversations by stating general greetings for the user if the user may be a new customer or personalized greetings for the user if the user may be a known customer. Embodiments may also include asking a list of questions to the user. In some embodiments, the list of questions may be customized for the user.

Embodiments may also include confirming if the user status may be ready and the user has positive emotion to continue. In some embodiments, the intelligence engine may be configured to switch topics or end the conversation if the user may be not ready. Embodiments may also include detecting and tracking the user's face, eye, and pose by a set of outward-facing cameras coupled to the one or more processors.

In some embodiments, a set of touch screens coupled to the one or more processors may be configured to allow the user to interact with the virtual agent by hand. Embodiments may also include using the set of outward-facing cameras to capture users' status to evaluate engagement. Embodiments may also include and decide the response or trigger topics and contents of the conversations.

Embodiments may also include detecting the user's voice by a set of microphones coupled to the one or more processors. In some embodiments, the set of microphones may be connected to loudspeakers. In some embodiments, the set of microphones may be enabled to be beamforming. In some embodiments, pictures or voices of the user may be configured to be uploaded and processed either on a cloud server or in local or personal devices to analyze and create the virtual agent.

In some embodiments, the visual agent may be configured to be created based on the appearance of a real human character, a popular cartoon character. In some embodiments, the virtual agent may be related to a personality shown in the advertisement of the area. In some embodiments, the artificial intelligence engine may be configured to understand users' status from voice and language.

Embodiments may also include detecting background noise in an environment during the conversation. Embodiments may also include analyzing levels of the background noise in the environment during the conversation. Embodiments may also include recognizing the voice information of the user in the conversation. In some embodiments, the artificial intelligence may be configured to tell the voice information of the user from the background noise by methods of voice re-identification, voice-and-face correlation, voice distance correlation.

In some embodiments, voice-and-face correlation may be based on model fitting of simultaneous emission of facial and vocal expressions. In some embodiments, the artificial may be configured to detect whether the user may be paying attention to the conversation by analyzing the facial and vocal expressions from the user. Embodiments may also include receiving responses from the user.

In some embodiments, the responses may include voice, facial expressions, body language, motion, poses and gestures. Embodiments may also include analyzing the user's status. In some embodiments, the user status may include psychological status, emotion and insights. Embodiments may also include setting a limit for a confidence level of recognition of the voice information of the user in the conversation.

In some embodiments, the confidence level in real time may be decided by an interactive method. In some embodiments, the continuation of the conversation may be decided by comparing the confidence level in real time with the limit. Embodiments may also include initiating a question to the user when the confidence level may be lower than the limit.

Embodiments may also include confirming if the artificial intelligence system understands user information correctly. Embodiments may also include apologizing to the user when the artificial intelligence cannot understand user information and asking for the user to repeat the last information from the user. Embodiments may also include changing the confidence level to a higher value and comparing the changed confidence level to the limit.

Embodiments may also include continuing the conversation when the confidence level may be higher than the limit. Embodiments may also include using tree-based or rule-based strategy to decide responses to the responses from the user. Embodiments may also include confirming that the user's status may be aligned with the AI engine's real-time evaluation.

Embodiments may also include checking the completion status of the set of goals in real-time. In some embodiments, if the set of goals may be not reached, the AI engine may be configured to continue the conversations. In some embodiments, if the set of goals may be reached, the AI engine may be configured to suggest to end the conversations. In some embodiments, if the user's responses may be not positively driving, the AI engine may be configured to revise the set of goals during the conversation by mitigating the unsatisfied responses from the user.

Embodiments of the present disclosure may also include a method for providing an artificial intelligence system with ability to reduce impact from background noise within an area, the method including setting a set of goals before conversations with a user. In some embodiments, the artificial intelligence system may include an artificial intelligence engine.

In some embodiments, an artificial intelligence engine may be configured to actively drive the conversations. In some embodiments, the set of goals may be related to the conversations. In some embodiments, the conversations may relate to any of processes of sales, meditation, teaching, consulting, training, and mental health treatment.

Embodiments may also include detecting, by one or more processors, the user in proximity with the artificial intelligence. In some embodiments, an artificial intelligence engine in the artificial intelligence system may be coupled to the one or more processors and a server. In some embodiments, the artificial intelligence engine may be trained by human experts in the field.

In some embodiments, a virtual agent may be configured to be displayed in LED/OLED displays, Android/iOS tablets, Laptops/PCs, smartphones, or VR/AR goggles. Embodiments may also include initiating conversations by stating general greetings for the user if the user may be a new customer or personalized greetings for the user if the user may be a known customer.

Embodiments may also include asking a list of questions to the user. In some embodiments, the list of questions may be customized for the user. Embodiments may also include confirming if the user status may be ready and the user has positive emotion to continue. In some embodiments, the intelligence engine may be configured to switch topics or end the conversation if the user may be not ready.

Embodiments may also include detecting and tracking the user's face, eye, and pose by a set of outward-facing cameras coupled to the one or more processors. In some embodiments, a set of touch screens coupled to the one or more processors may be configured to allow the user to interact with the virtual agent by hand. Embodiments may also include using the set of outward-facing cameras to capture users' status to evaluate engagement.

Embodiments may also include and decide the response or trigger topics and contents of the conversations. Embodiments may also include detecting the user's voice by a set of microphones coupled to the one or more processors. In some embodiments, the set of microphones may be connected to loudspeakers. In some embodiments, the set of microphones may be enabled to be beamforming.

In some embodiments, pictures or voices of the user may be configured to be uploaded and processed either on a cloud server or in local or personal devices to analyze and create the virtual agent. In some embodiments, the visual agent may be configured to be created based on the appearance of a real human character, a popular cartoon character. In some embodiments, the virtual agent may be related to a personality shown in the advertisement of the area.

In some embodiments, the artificial intelligence engine may be configured to understand users' status from voice and language. Embodiments may also include detecting background noise in an environment during the conversation. Embodiments may also include analyzing levels of the background noise in the environment during the conversation.

Embodiments may also include recognizing the voice information of the user in the conversation. In some embodiments, the artificial intelligence may be configured to tell the voice information of the user from the background noise by methods of voice re-identification, voice-and-face correlation, voice distance correlation. In some embodiments, voice-and-face correlation may be based on model fitting of simultaneous emission of facial and vocal expressions.

In some embodiments, the artificial may be configured to detect whether the user may be paying attention to the conversation by analyzing the facial and vocal expressions from the user. Embodiments may also include receiving responses from the user. In some embodiments, the responses may include voice, facial expressions, body language, motion, poses and gestures.

Embodiments may also include analyzing the user's status. In some embodiments, the user status may include psychological status, emotion and insights. Embodiments may also include setting a limit for a confidence level of recognition of the voice information of the user in the conversation. In some embodiments, the confidence level in real time may be decided by an interactive method.

In some embodiments, the continuation of the conversation may be decided by comparing the confidence level in real time with the limit. Embodiments may also include initiating a question to the user when the confidence level may be lower than the limit. Embodiments may also include confirming if the artificial intelligence system understands user information correctly.

Embodiments may also include apologizing to the user when the artificial intelligence cannot understand user information and asking for the user to repeat the last information from the user. Embodiments may also include changing the confidence level to a higher value and comparing the changed confidence level to the limit. Embodiments may also include continuing the conversation when the confidence level may be higher than the limit.

Embodiments may also include using tree-based or rule-based strategy to decide responses to the responses from the user. Embodiments may also include confirming that the user's status may be aligned with the AI engine's real-time evaluation. Embodiments may also include checking the completion status of the set of goals in real-time.

In some embodiments, if the set of goals may be not reached, the AI engine may be configured to continue the conversations. In some embodiments, if the set of goals may be reached, the AI engine may be configured to suggest to end the conversations. In some embodiments, if the user's responses may be not positively driving, the AI engine may be configured to revise the set of goals during the conversation by mitigating the unsatisfied responses from the user.

### BRIEF DESCRIPTION OF THE FIGURES

FIG. 1A is a flowchart illustrating a method for providing an artificial intelligence system, according to some embodiments of the present disclosure.

FIG. 1B is a flowchart extending from FIG. 1A and further illustrating the method for providing an artificial intelligence system, according to some embodiments of the present disclosure.

FIG. 1C is a flowchart extending from FIG. 1B and further illustrating the method for providing an artificial intelligence system from FIG. 1A, according to some embodiments of the present disclosure.

FIG. 1D is a flowchart extending from FIG. 1C and further illustrating the method for providing an artificial intelligence system from FIG. 1A, according to some embodiments of the present disclosure.

FIG. 2A is a flowchart illustrating a method for providing an artificial intelligence system, according to some embodiments of the present disclosure.

FIG. 2B is a flowchart extending from FIG. 2A and further illustrating the method for providing an artificial intelligence system, according to some embodiments of the present disclosure.

FIG. 2C is a flowchart extending from FIG. 2B and further illustrating the method for providing an artificial intelligence system from FIG. 2A, according to some embodiments of the present disclosure.

FIG. 2D is a flowchart extending from FIG. 2C and further illustrating the method for providing an artificial intelligence system from FIG. 2A, according to some embodiments of the present disclosure.

FIG. 3A is a flowchart illustrating a method for providing an artificial intelligence system, according to some embodiments of the present disclosure.

FIG. 3B is a flowchart extending from FIG. 3A and further illustrating the method for providing an artificial intelligence system, according to some embodiments of the present disclosure.

FIG. 3C is a flowchart extending from FIG. 3B and further illustrating the method for providing an artificial intelligence system from FIG. 3A, according to some embodiments of the present disclosure.

FIG. 3D is a flowchart extending from FIG. 3C and further illustrating the method for providing an artificial intelligence system from FIG. 3A, according to some embodiments of the present disclosure.

FIG. 4 is a diagram showing an example of a system that can implement the method for providing an artificial intelligence system, according to some embodiments, according to some embodiments of the present disclosure.

FIG. 5 is a diagram showing a second example of a system that can implement the method for providing an artificial intelligence system, according to some embodiments, according to some embodiments of the present disclosure.

FIG. 6 is a diagram showing a third example of a system that can implement the method for providing an artificial intelligence system, according to some embodiments, according to some embodiments of the present disclosure.

FIG. 7 is a diagram showing a fourth example of a system that can implement the method for providing an artificial intelligence system, according to some embodiments, according to some embodiments of the present disclosure.

FIG. 8 is a diagram showing a fifth example of a system that can implement the method for providing an artificial intelligence system, according to some embodiments, according to some embodiments of the present disclosure.

FIG. 9 is a diagram showing a sixth example of a system that can implement the method for providing an artificial intelligence system, according to some embodiments, according to some embodiments of the present disclosure.

FIG. 10 is a diagram showing a seventh example of a system that can implement the method for providing an artificial intelligence system, according to some embodiments, according to some embodiments of the present disclosure.

### DETAILED DESCRIPTION

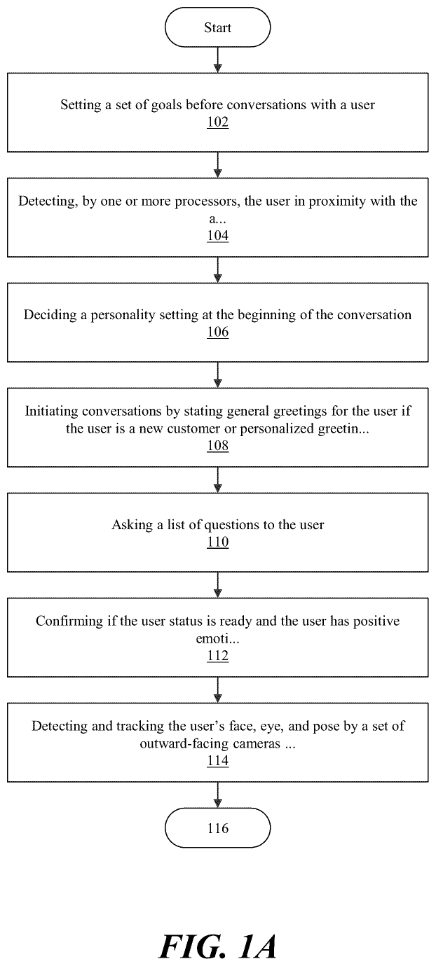

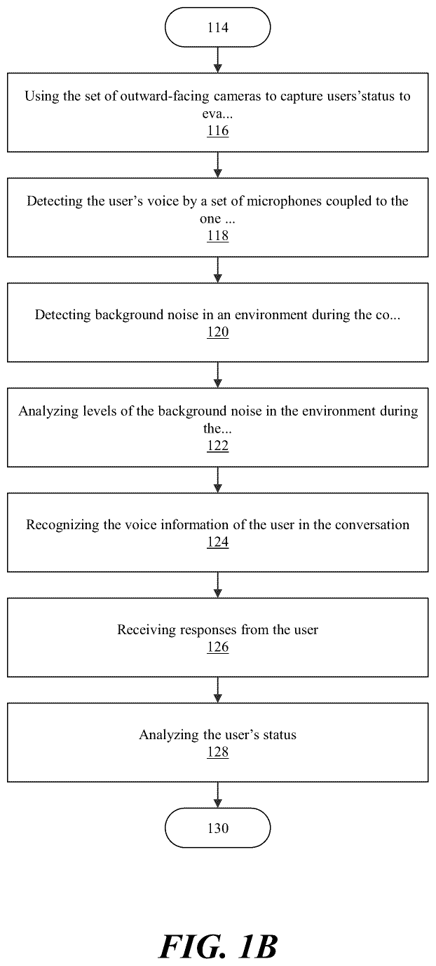

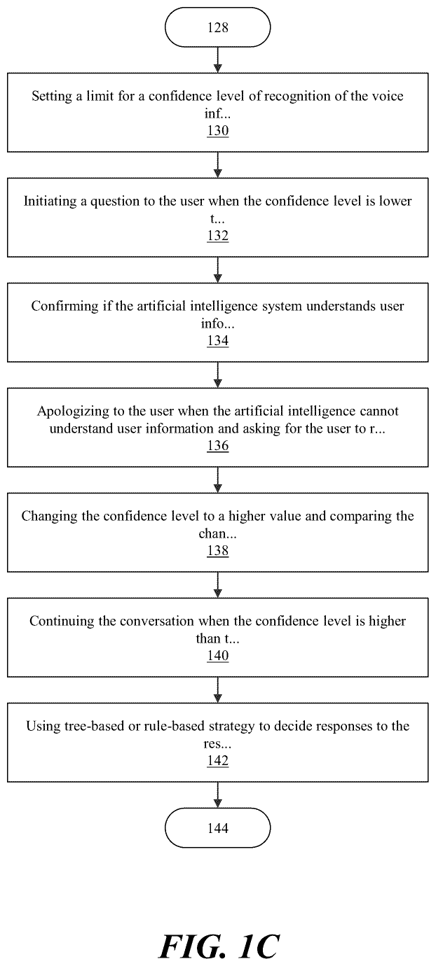

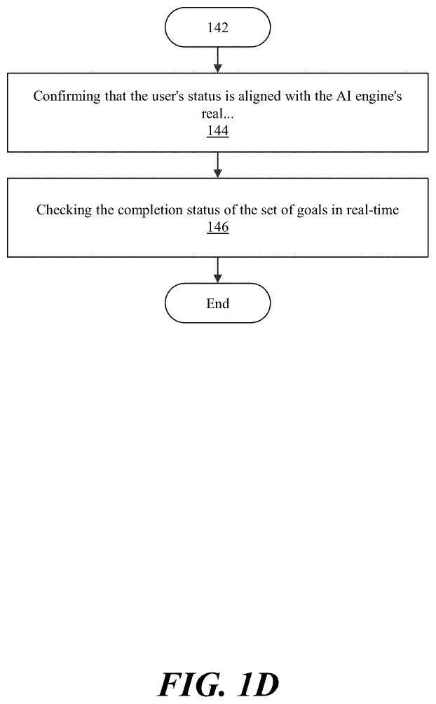

FIGS. 1A to 1D are flowcharts that describe a method for providing an artificial intelligence system, according to some embodiments of the present disclosure. In some embodiments, at 102, the method may include setting a set of goals before conversations with a user. At 104, the method may include detecting, by one or more processors, the user in proximity with the artificial intelligence. At 106, the method may include deciding a personality setting at the beginning of the conversation. At 108, the method may include initiating conversations by stating general greetings for the user if the user may be a new customer or personalized greetings for the user if the user may be a known customer.

In some embodiments, at 110, the method may include asking a list of questions to the user. At 112, the method may include confirming if the user status may be ready and the user has positive emotion to continue. At 114, the method may include detecting and tracking the user's face, eye, and pose by a set of outward-facing cameras coupled to the one or more processors. At 116, the method may include using the set of outward-facing cameras to capture users' status to evaluate engagement.

In some embodiments, at 118, the method may include detecting the user's voice by a set of microphones coupled to the one or more processors. At 120, the method may include detecting background noise in an environment during the conversation. At 122, the method may include analyzing levels of the background noise in the environment during the conversation. At 124, the method may include recognizing the voice information of the user in the conversation.

In some embodiments, at 126, the method may include receiving responses from the user. At 128, the method may include analyzing the user's status. At 130, the method may include setting a limit for a confidence level of recognition of the voice information of the user in the conversation. At 134, the method may include confirming if the artificial intelligence system understands user information correctly. At 138, the method may include changing the confidence level to a higher value and comparing the changed confidence level to the limit.

In some embodiments, at 140, the method may include continuing the conversation when the confidence level may be higher than the limit. At 142, the method may include using tree-based or rule-based strategy to decide responses to the responses from the user. At 144, the method may include confirming that the user's status may be aligned with the AI engine's real-time evaluation. At 146, the method may include checking the completion status of the set of goals in real-time.

In some embodiments, the artificial intelligence system may comprise an artificial intelligence engine. An artificial intelligence engine may be configured to actively drive the conversations. The set of goals may be related to the conversations. The conversations may relate to any of processes of sales, meditation, teaching, consulting, training, and mental health treatment. An artificial intelligence engine in the artificial intelligence system may be coupled to the one or more processors and a server.

In some embodiments, the artificial intelligence engine may be trained by human experts in the field. A virtual agent may be configured to be displayed in LED/OLED displays, Android/iOS tablets, Laptops/PCs, smartphones, or VR/AR goggles. A set of multi-layer info panels coupled to the one or more processors may be configured to overlay graphics on top of the virtual agent. The visual agent may be configured to be displayed with an appearance of a real human or a humanoid or a cartoon character.

In some embodiments, the virtual agent's gender, age and ethnicity may be determined by the artificial Intelligence engine's analysis on input from the user. The visual agent may be configured to be displayed in full body or half body portrait mode. The artificial intelligence engine may be configured for real-time speech recognition, speech to text generation, real-time dialog generation, text to speech generation, voice-driven animation, and human avatar generation.

In some embodiments, the artificial intelligence engine may be configured to emulate different voices and use different languages. The AI engine may be configured to follow the personality setting during the conversation. The list of questions may be customized for the user. The intelligence engine may be configured to switch topics or end the conversation if the user may be not ready. A set of touch screens coupled to the one or more processors may be configured to allow the user to interact with the virtual agent by hand.

In some embodiments, and decide the response or trigger topics and contents of the conversations. The set of microphones may be connected to loudspeakers. The set of microphones may be enabled to be beamforming. Pictures or voices of the user may be configured to be uploaded and processed either on a cloud server or in local or personal devices to analyze and create the virtual agent. The visual agent may be configured to be created based on the appearance of a real human character, a popular cartoon character.

In some embodiments, the virtual agent may be related to a personality shown in the advertisement of the area. The artificial intelligence engine may be configured to understand users' status from voice and language. The artificial intelligence may be configured to tell the voice information of the user from the background noise by methods of voice re-identification, voice-and-face correlation, voice distance correlation.

In some embodiments, Voice-and-face correlation may be based on model fitting of simultaneous emission of facial and vocal expressions. The artificial may be configured to detect whether the user may be paying attention to the conversation by analyzing the facial and vocal expressions from the user. The responses may comprise voice, facial expressions, body language, motion, poses and gestures. The user status may comprise psychological status, emotion and insights.

In some embodiments, at 132, the setting may include initiating a question to the user when the confidence level may be lower than the limit. The confidence level in real-time may be decided by an interactive method. The continuation of the conversation may be decided by comparing the confidence level in real-time with the limit. At 136, the confirming may include apologizing to the user when the artificial intelligence cannot understand user information and asking for the user to repeat the last information from the user. If the set of goals may be not reached, the AI engine may be configured to continue the conversations. If the set of goals may be reached, the AI engine may be configured to suggest to end the conversations. If the user's responses may be not positively driving, the AI engine may be configured to revise the set of goals during the conversation by mitigating the unsatisfied responses from the user.

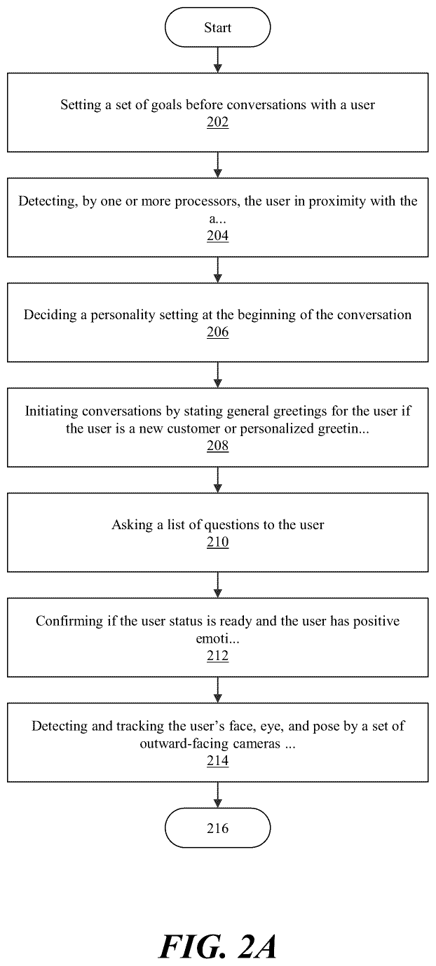

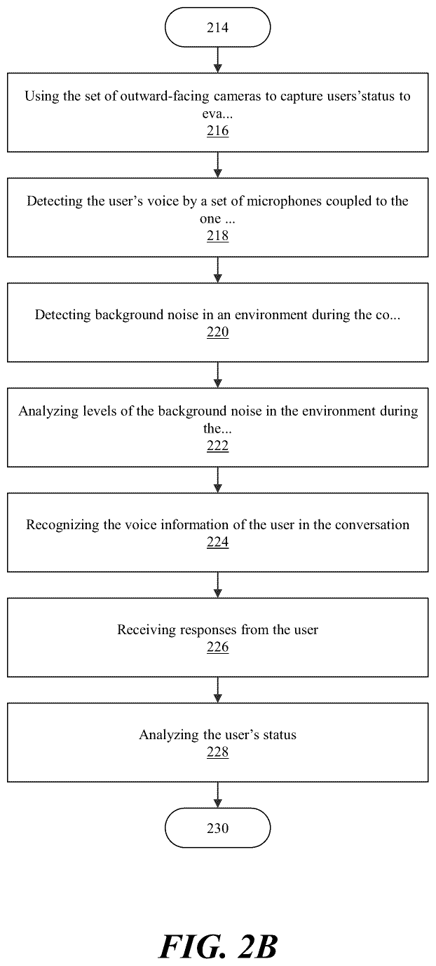

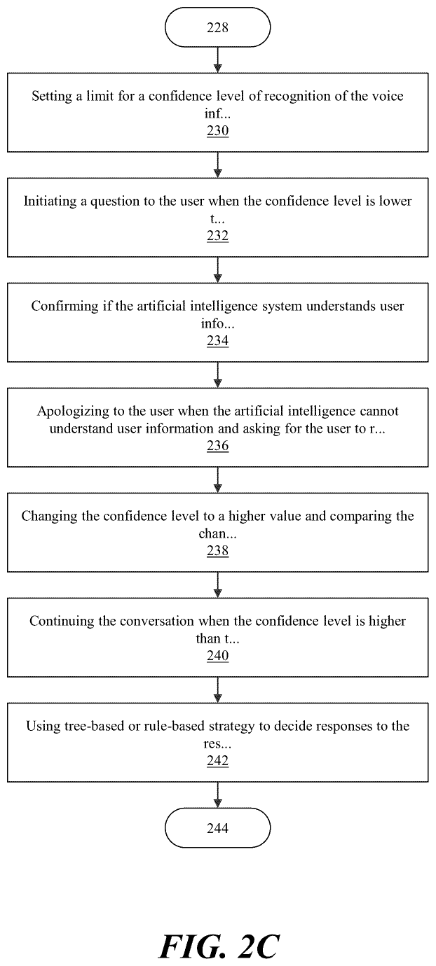

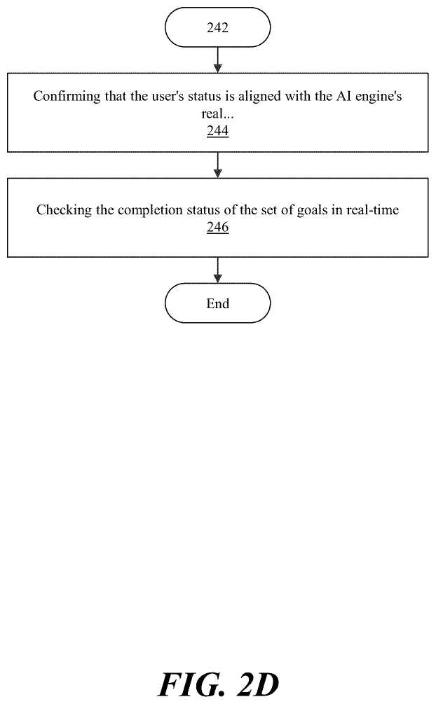

FIGS. 2A to 2D are flowcharts that describe a method for providing an artificial intelligence system, according to some embodiments of the present disclosure. In some embodiments, at 202, the method may include setting a set of goals before conversations with a user. At 204, the method may include detecting, by one or more processors, the user in proximity with the artificial intelligence. At 206, the method may include deciding a personality setting at the beginning of the conversation. At 208, the method may include initiating conversations by stating general greetings for the user if the user may be a new customer or personalized greetings for the user if the user may be a known customer.

In some embodiments, at 210, the method may include asking a list of questions to the user. At 212, the method may include confirming if the user status may be ready and the user has positive emotion to continue. At 214, the method may include detecting and tracking the user's face, eye, and pose by a set of outward-facing cameras coupled to the one or more processors. At 216, the method may include using the set of outward-facing cameras to capture users' status to evaluate engagement.

In some embodiments, at 218, the method may include detecting the user's voice by a set of microphones coupled to the one or more processors. At 220, the method may include detecting background noise in an environment during the conversation. At 222, the method may include analyzing levels of the background noise in the environment during the conversation. At 224, the method may include recognizing the voice information of the user in the conversation.

In some embodiments, at 226, the method may include receiving responses from the user. At 228, the method may include analyzing the user's status. At 230, the method may include setting a limit for a confidence level of recognition of the voice information of the user in the conversation. At 232, the method may include initiating a question to the user when the confidence level may be lower than the limit. At 234, the method may include confirming if the artificial intelligence system understands user information correctly.

In some embodiments, at 238, the method may include changing the confidence level to a higher value and comparing the changed confidence level to the limit. At 240, the method may include continuing the conversation when the confidence level may be higher than the limit. At 242, the method may include using tree-based or rule-based strategy to decide responses to the responses from the user. At 244, the method may include confirming that the user's status may be aligned with the AI engine's real-time evaluation. At 246, the method may include checking the completion status of the set of goals in real-time.

In some embodiments, the artificial intelligence system may comprise an artificial intelligence engine. An artificial intelligence engine may be configured to actively drive the conversations. The set of goals may be related to the conversations. The conversations may relate to any of processes of sales, meditation, teaching, consulting, training, and mental health treatment. An artificial intelligence engine in the artificial intelligence system may be coupled to the one or more processors and a server.

In some embodiments, the artificial intelligence engine may be trained by human experts in the field. A virtual agent may be configured to be displayed in LED/OLED displays, Android/iOS tablets, Laptops/PCs, smartphones, or VR/AR goggles. A set of multi-layer info panels coupled to the one or more processors may be configured to overlay graphics on top of the virtual agent. The visual agent may be configured to be displayed with an appearance of a real human or a humanoid or a cartoon character.

In some embodiments, the virtual agent's gender, age and ethnicity may be determined by the artificial Intelligence engine's analysis on input from the user. The AI engine may be configured to follow the personality setting during the conversation. The list of questions may be customized for the user. The intelligence engine may be configured to switch topics or end the conversation if the user may be not ready. A set of touch screens coupled to the one or more processors may be configured to allow the user to interact with the virtual agent by hand.

In some embodiments, and decide the response or trigger topics and contents of the conversations. The set of microphones may be connected to loudspeakers. The set of microphones may be enabled to be beamforming. Pictures or voices of the user may be configured to be uploaded and processed either on a cloud server or in local or personal devices to analyze and create the virtual agent. The visual agent may be configured to be created based on the appearance of a real human character, a popular cartoon character.

In some embodiments, the virtual agent may be related to a personality shown in the advertisement of the area. The artificial intelligence engine may be configured to understand users' status from voice and language. The artificial intelligence may be configured to tell the voice information of the user from the background noise by methods of voice re-identification, voice-and-face correlation, voice distance correlation.

In some embodiments, Voice-and-face correlation may be based on model fitting of simultaneous emission of facial and vocal expressions. The artificial may be configured to detect whether the user may be paying attention to the conversation by analyzing the facial and vocal expressions from the user. The responses may comprise voice, facial expressions, body language, motion, poses and gestures. The user status may comprise psychological status, emotion and insights.

In some embodiments, the confidence level in real time may be decided by an interactive method. The continuation of the conversation may be decided by comparing the confidence level in real time with the limit. At 236, the confirming may include apologizing to the user when the artificial intelligence cannot understand user information and asking for the user to repeat the last information from the user. If the set of goals may be not reached, the AI engine may be configured to continue the conversations. If the set of goals may be reached, the AI engine may be configured to suggest to end the conversations. If the user's responses may be not positively driving, the AI engine may be configured to revise the set of goals during the conversation by mitigating the unsatisfied responses from the user.

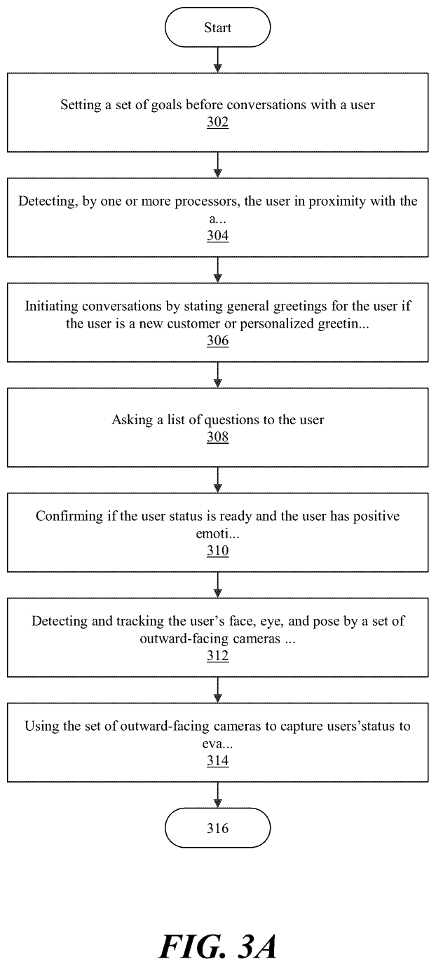

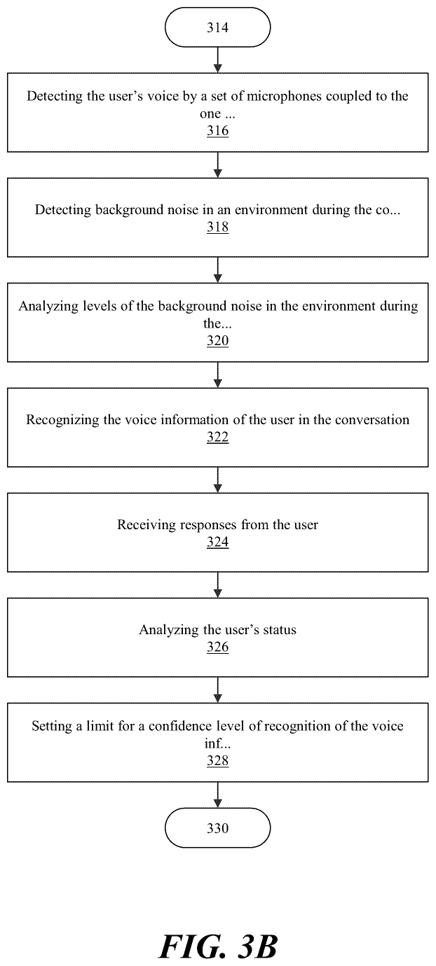

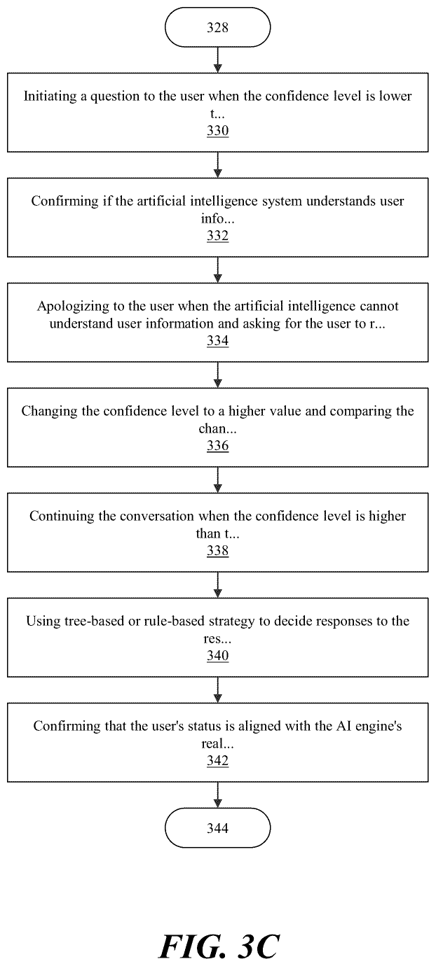

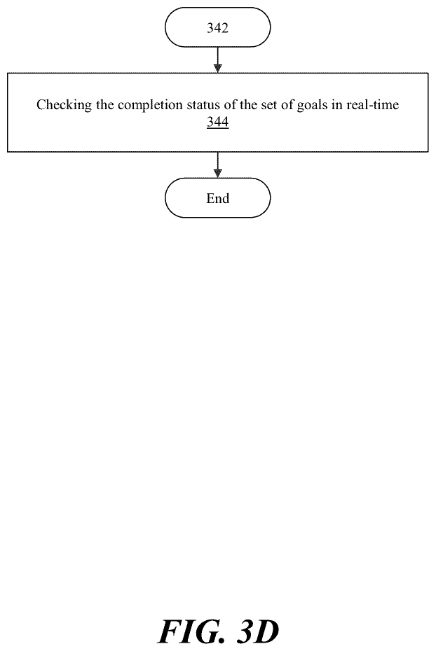

FIGS. 3A to 3D are flowcharts that describe a method for providing an artificial intelligence system, according to some embodiments of the present disclosure. In some embodiments, at 302, the method may include setting a set of goals before conversations with a user. At 304, the method may include detecting, by one or more processors, the user in proximity with the artificial intelligence. At 306, the method may include initiating conversations by stating general greetings for the user if the user may be a new customer or personalized greetings for the user if the user may be a known customer.

In some embodiments, at 308, the method may include asking a list of questions to the user. At 310, the method may include confirming if the user status may be ready and the user has positive emotion to continue. At 312, the method may include detecting and tracking the user's face, eye, and pose by a set of outward-facing cameras coupled to the one or more processors. At 314, the method may include using the set of outward-facing cameras to capture users' status to evaluate engagement.

In some embodiments, at 316, the method may include detecting the user's voice by a set of microphones coupled to the one or more processors. At 318, the method may include detecting background noise in an environment during the conversation. At 320, the method may include analyzing levels of the background noise in the environment during the conversation. At 322, the method may include recognizing the voice information of the user in the conversation.

In some embodiments, at 324, the method may include receiving responses from the user. At 326, the method may include analyzing the user's status. At 328, the method may include setting a limit for a confidence level of recognition of the voice information of the user in the conversation. At 330, the method may include initiating a question to the user when the confidence level may be lower than the limit. At 332, the method may include confirming if the artificial intelligence system understands user information correctly.

In some embodiments, at 336, the method may include changing the confidence level to a higher value and comparing the changed confidence level to the limit. At 338, the method may include continuing the conversation when the confidence level may be higher than the limit. At 340, the method may include using tree-based or rule-based strategy to decide responses to the responses from the user. At 342, the method may include confirming that the user's status may be aligned with the AI engine's real-time evaluation. At 344, the method may include checking the completion status of the set of goals in real-time.

In some embodiments, the artificial intelligence system may comprise an artificial intelligence engine. An artificial intelligence engine may be configured to actively drive the conversations. The set of goals may be related to the conversations. The conversations may relate to any of processes of sales, meditation, teaching, consulting, training, and mental health treatment. An artificial intelligence engine in the artificial intelligence system may be coupled to the one or more processors and a server.

In some embodiments, the artificial intelligence engine may be trained by human experts in the field. A virtual agent may be configured to be displayed in LED/OLED displays, Android/iOS tablets, Laptops/PCs, smartphones, or VR/AR goggles. The list of questions may be customized for the user. The intelligence engine may be configured to switch topics or end the conversation if the user may be not ready. A set of touch screens coupled to the one or more processors may be configured to allow the user to interact with the virtual agent by hand.

In some embodiments, and decide the response or trigger topics and contents of the conversations. The set of microphones may be connected to loudspeakers. The set of microphones may be enabled to be beamforming. Pictures or voices of the user may be configured to be uploaded and processed either on a cloud server or in local or personal devices to analyze and create the virtual agent. The visual agent may be configured to be created based on the appearance of a real human character, a popular cartoon character.

In some embodiments, the virtual agent may be related to a personality shown in the advertisement of the area. The artificial intelligence engine may be configured to understand users' status from voice and language. The artificial intelligence may be configured to tell the voice information of the user from the background noise by methods of voice re-identification, voice-and-face correlation, voice distance correlation.

In some embodiments, Voice-and-face correlation may be based on model fitting of simultaneous emission of facial and vocal expressions. The artificial may be configured to detect whether the user may be paying attention to the conversation by analyzing the facial and vocal expressions from the user. The responses may comprise voice, facial expressions, body language, motion, poses and gestures. The user status may comprise psychological status, emotion and insights.

In some embodiments, the confidence level in real time may be decided by an interactive method. The continuation of the conversation may be decided by comparing the confidence level in real time with the limit. At 334, the confirming may include apologizing to the user when the artificial intelligence cannot understand user information and asking for the user to repeat the last information from the user. If the set of goals may be not reached, the AI engine may be configured to continue the conversations. If the set of goals may be reached, the AI engine may be configured to suggest to end the conversations. If the user's responses may be not positively driving, the AI engine may be configured to revise the set of goals during the conversation by mitigating the unsatisfied responses from the user.

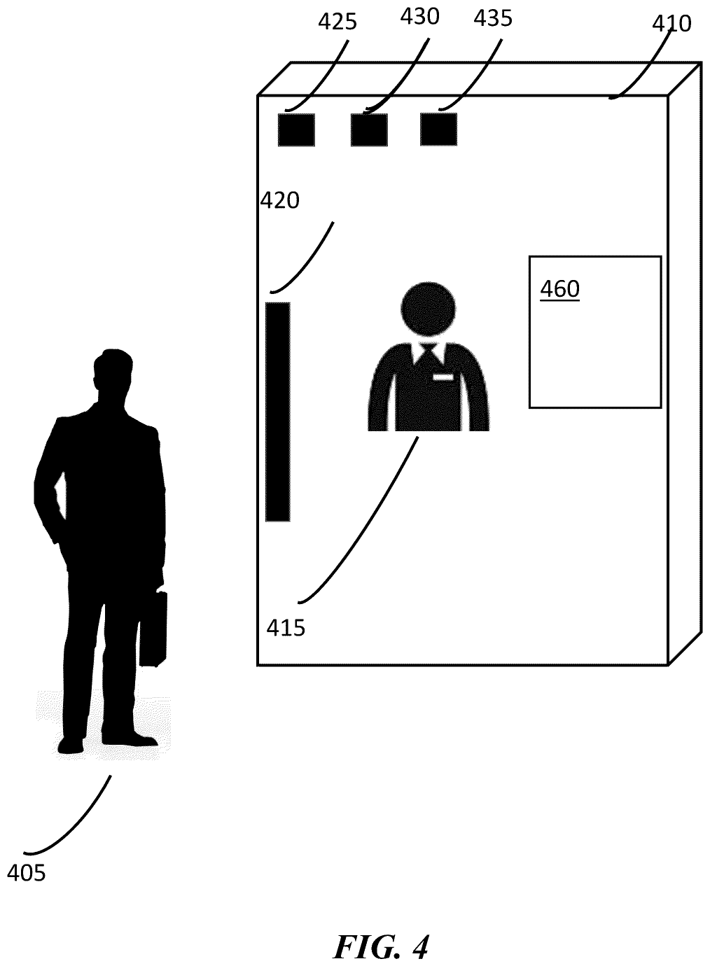

FIG. 4 is a diagram showing an example that describes a first example of a system that can implement the method for providing an artificial intelligence system, according to some embodiments, according to some embodiments of the present disclosure.

In some embodiments, a user 405 can approach a smart display 410. In some embodiments, the smart display 410 could be LED or OLED-based. In some embodiments, interactive panels 420 are attached to the smart display 410. In some embodiments, camera 425, sensor 430 and microphone 435 are attached to the smart display 410. In some embodiments, an artificial intelligence visual assistant 415 is active on the smart display 410. In some embodiments, a visual working agenda 460 is shown on the smart display 410. In some embodiments, user 405 can approach the smart display 410 and initiate and complete the intended business with the visual assistant 415 by the methods described in FIG. 1-FIG. 3. In some embodiments, interactive panel 420 is coupled to a central processor. In some embodiments, interactive panel 420 is coupled to a server via a wireless link. In some embodiments, user 405 can interact with the visual assistant 415 via camera 425, sensor 430 and microphone 435 using methods described in FIG. 1-FIG. 3, with the help of interactive panel 420. In some embodiments, user 405 can choose what language to be used.

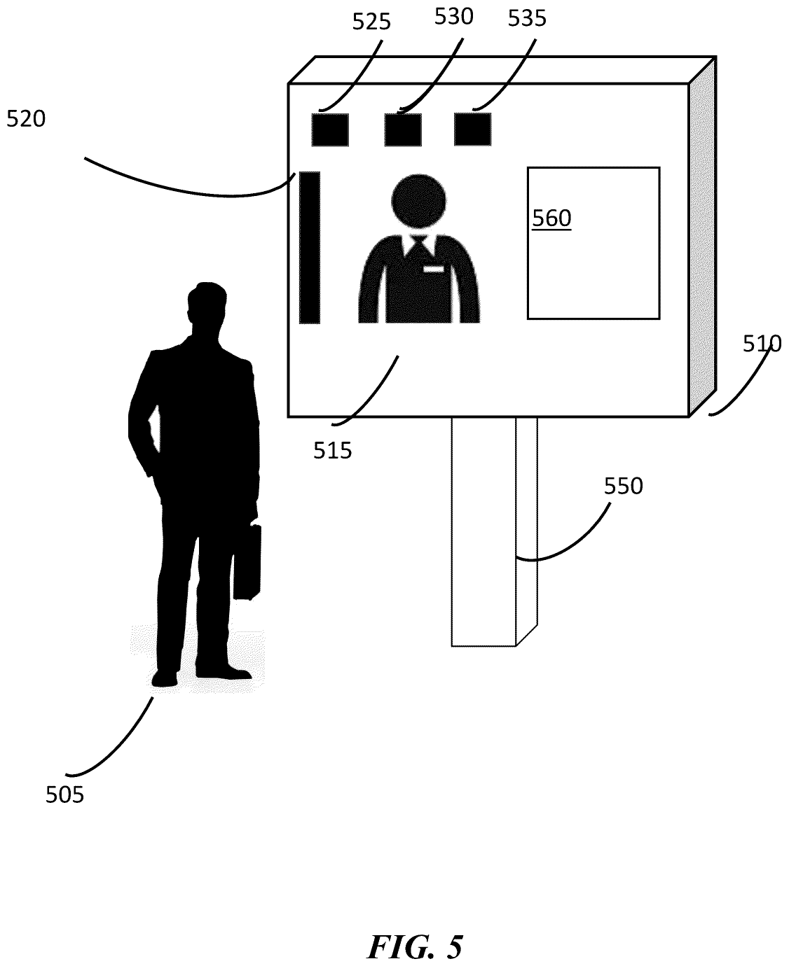

FIG. 5 is a diagram showing a second example of a system that can implement the method for providing an artificial intelligence system, according to some embodiments, according to some embodiments of the present disclosure.

In some embodiments, a user 505 can approach a smart display 510. In some embodiments, the smart display 510 could be LED or OLED-based. In some embodiments, interactive panels 520 are attached to the smart display 510. In some embodiments, camera 525, sensor 530, and microphone 535 are attached to the smart display 510. In some embodiments, a support column 550 is attached to the smart display 510. In some embodiments, an artificial intelligence visual assistant 515 is active on the smart display 510. In some embodiments, a visual working agenda 560 is shown on the smart display 510. In some embodiments, user 505 can approach the smart display 510 and initiate and complete the business process with the visual assistant 515 by the methods described in FIG. 1-FIG. 3. In some embodiments, interactive panel 520 is coupled to a central processor. In some embodiments, interactive panel 520 is coupled to a server via a wireless link. In some embodiments, user 505 can interact with the visual assistant 515 via camera 525, sensor 530 and microphone 535 using methods described in FIG. 1-FIG. 3., with the help of interactive panel 520. In some embodiments, user 505 can choose what language to be used.

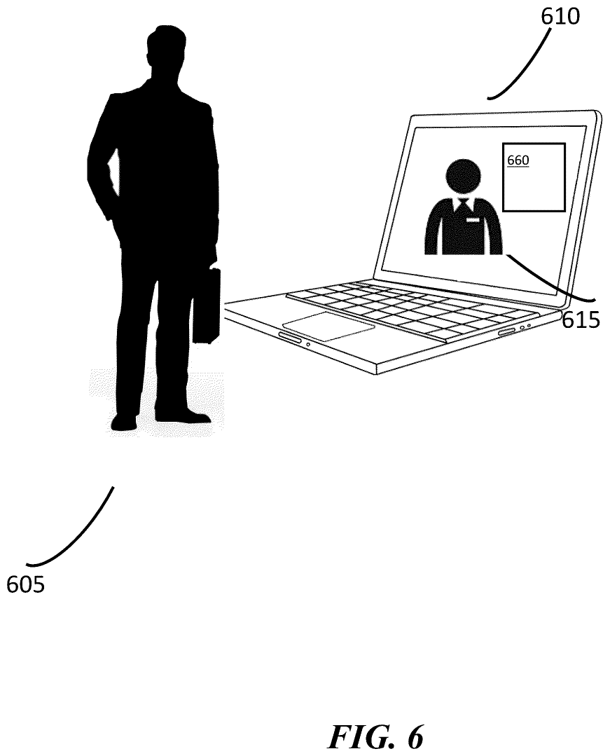

FIG. 6 is a diagram showing a third example of a system that can implement the method for providing an artificial intelligence system, according to some embodiments, according to some embodiments of the present disclosure.

In some embodiments, a user 605 can approach a smart display 610. In some embodiments, the smart display 610 could be LED or OLED-based. In some embodiments, the display 610 could be a part of a desktop computer, a laptop computer or a tablet computer. In some embodiments, a camera, sensor, and microphone are attached to the smart display 610. In some embodiments, an artificial intelligence visual assistant 615 is active on the smart display 610. In some embodiments, a visual working agenda 660 is shown on the smart display 610. In some embodiments, user 605 can approach the smart display 610 and initiate and complete the business process with the visual assistant 615 by the methods described in FIG. 1-FIG. 3. In some embodiments, a keyboard is coupled to a central processor. In some embodiments, a keyboard is coupled to a server via a wireless link. In some embodiments, user 605 can interact with the visual assistant 615 via a camera, sensor and microphone using methods described in FIG. 1-FIG. 3, with the help of the keyboard. In some embodiments, user 605 can choose what language to use.

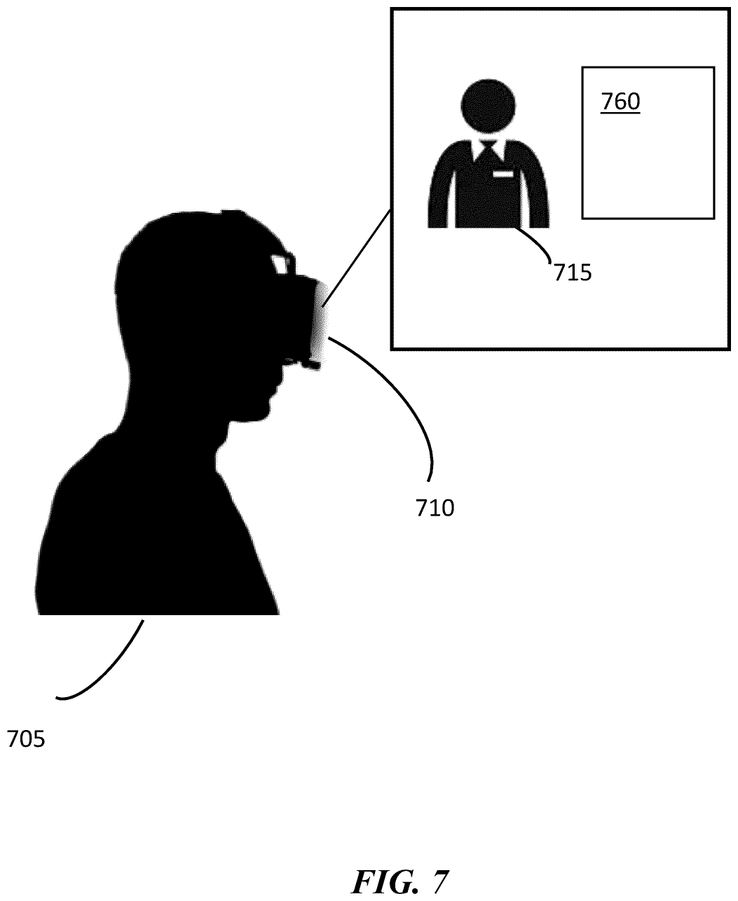

FIG. 7 is a diagram showing a fourth example of a system that can implement the method for providing an artificial intelligence system, according to some embodiments, according to some embodiments of the present disclosure.

In some embodiments, a user 705 can view programs including news with a VR or AR device 710. In some embodiments, a processor and a server are connected to the VR or AR device 710. In some embodiments, an interactive keyboard is connected to the VR or AR device 710. In some embodiments, an AI visual assistant 715 is active on the VR or AR device 710. In some embodiments, a visual working agenda 760 is shown on the VR or AR 710. In some embodiments, user 705 can initiate and complete the business process with the visual assistant 705 via the VR or AR device 715 by the methods described in FIG. 1-FIG. 3. In some embodiments, an interactive panel is coupled to a central processor. In some embodiments, an interactive panel is coupled to a server via a wireless link. In some embodiments, the user 705 can choose what language to use.

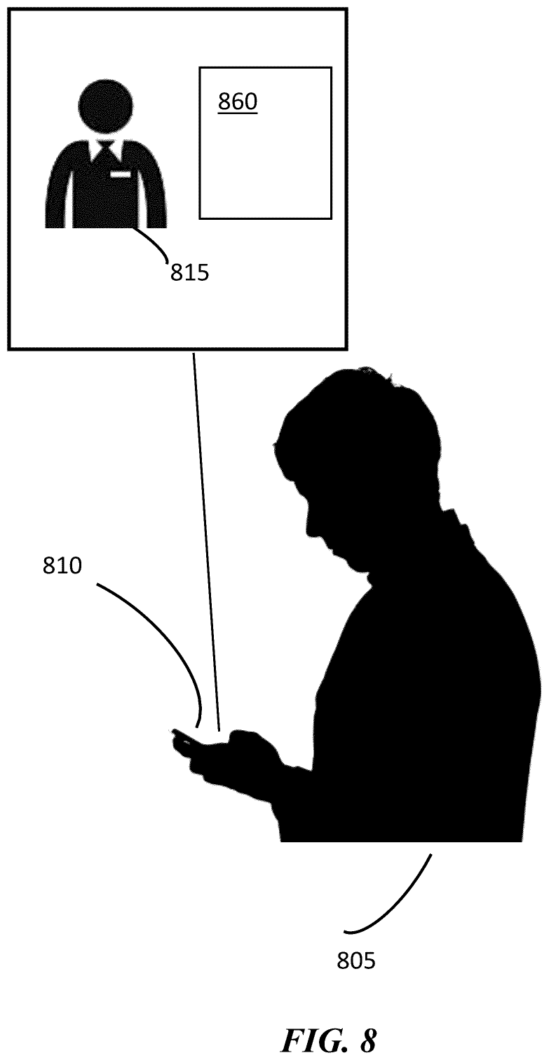

FIG. 8 is a diagram showing a fifth example of a system that can implement the method for providing an artificial intelligence system, according to some embodiments, according to some embodiments of the present disclosure.

In some embodiments, a user 805 can view programs including news with a smartphone device 810. In some embodiments, a processor and a server are connected to the smartphone device 810. In some embodiments, an interactive keyboard is connected to the smartphone device 810. In some embodiments, an AI visual assistant 815 is active on the smartphone device 810. In some embodiments, a visual working agenda 860 is shown on the smartphone device 810. In some embodiments, user 805 can initiate and complete the business process with the visual assistant 815 via smartphone device 810 by the methods described in FIG. 1-FIG. 3. In some embodiments, an interactive panel is coupled to a central processor. In some embodiments, interactive panel is coupled to a server via a wireless link. In some embodiments, the user 805 can choose what language to be used.

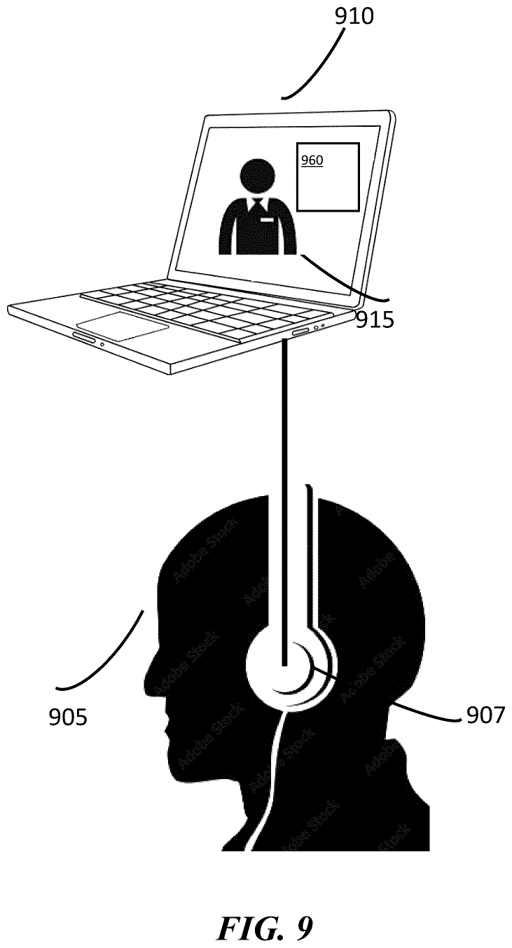

FIG. 9 is a diagram showing a sixth example of a system that can implement the method for providing an artificial intelligence system, according to some embodiments, according to some embodiments of the present disclosure.

In some embodiments, a user 905 has a brain-computer interface. In some embodiments, the user 905 may wear a headset 907 that can detect and translate the electric signal from the brain and communicate with the computer or other devices. The computer 910 or other devices are connected with a cable or wire to the headset. In some embodiments, a processor and a server are connected to the computer 910. In some embodiments, an interactive keyboard is connected to the computer 910. In some embodiments, an AI visual assistant 915 is active on the computer 910. In some embodiments, a visual working agenda 960 is shown on the computer 910. In some embodiments, user 905 can initiate and complete the business process with the visual assistant 905 via the computer 915 by the methods described in FIG. 1-FIG. 3. In some embodiments, an interactive panel is coupled to a central processor. In some embodiments, an interactive panel is coupled to a server via a wireless link. In some embodiments, the user 905 can choose what language to use.

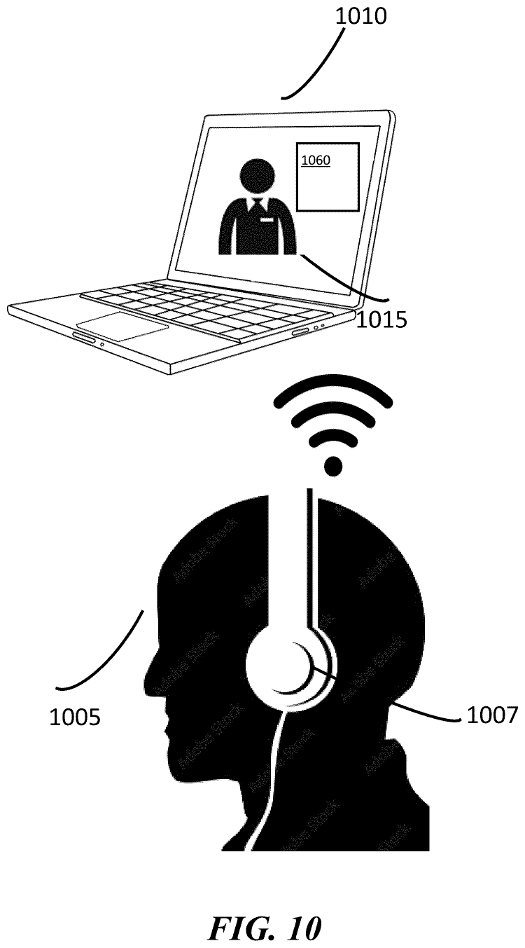

FIG. 10 is a diagram showing a seventh example of a system that can implement the method for providing an artificial intelligence system, according to some embodiments, according to some embodiments of the present disclosure.

In some embodiments, a user 1005 has a brain-computer interface. In some embodiments, the user 1005 may wear a headset 1007 that can detect and translate the electric signal from the brain and communicate with the computer or other devices. The computer 1010 or other devices are connected with wireless means to the headset. In some embodiments, a processor and a server are connected to the computer 1010. In some embodiments, an interactive keyboard is connected to the computer 1010. In some embodiments, an AI visual assistant 1015 is active on the computer 1010. In some embodiments, a visual working agenda 1060 is shown on the computer 1010. In some embodiments, user 1005 can initiate and complete the business process with the visual assistant 1005 via the computer 1015 by the methods described in FIG. 1-FIG. 3. In some embodiments, an interactive panel is coupled to a central processor. In some embodiments, an interactive panel is coupled to a server via a wireless link. In some embodiments, the user 1005 can choose what language to use.

1. A method for providing an artificial intelligence system with ability to reduce impact from background noise within an area, the method comprising:
setting a set of goals before conversations with a user, wherein the artificial intelligence system comprises an artificial intelligence engine, wherein an artificial intelligence engine is configured to actively drive the conversations, wherein the set of goals are related to the conversations, wherein the conversations may relate to any of processes of sales, meditation, teaching, consulting, training, and mental health treatment;
detecting, by one or more processors, the user in proximity with the artificial intelligence, wherein an artificial intelligence engine in the artificial intelligence system is coupled to the one or more processors and a server, wherein the artificial intelligence engine is trained by human experts in the field, wherein a virtual agent is configured to be displayed in LED/OLED displays, Android/iOS tablets, Laptops/PCs, smartphones, or VR/AR goggles, wherein a set of multi-layer info panels coupled to the one or more processors are configured to overlay graphics on top of the virtual agent, wherein the visual agent is configured to be displayed with an appearance of a real human or a humanoid or a cartoon character, wherein the virtual agent's gender, age and ethnicity is determined by the artificial Intelligence engine's analysis on input from the user, wherein the visual agent is configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages;
deciding a personality setting at the beginning of the conversation, wherein the AI engine is configured to follow the personality setting during the conversation;
initiating conversations by stating general greetings for the user if the user is a new customer or personalized greetings for the user if the user is a known customer;
asking a list of questions to the user, wherein the list of questions may be customized for the user;
confirming if the user status is ready and the user has positive emotion to continue, wherein the intelligence engine is configured to switch topics or end the conversation if the user is not ready;
detecting and tracking the user's face, eye, and pose by a set of outward-facing cameras coupled to the one or more processors, wherein a set of touch screens coupled to the one or more processors is configured to allow the user to interact with the virtual agent by hand;
using the set of outward-facing cameras to capture users' status to evaluate engagement and decide the response or trigger topics and contents of the conversations;
detecting the user's voice by a set of microphones coupled to the one or more processors, wherein the set of microphones are connected to loudspeakers, wherein the set of microphones are enabled to be beamforming, wherein pictures or voices of the user are configured to be uploaded and processed either on a cloud server or in local or personal devices to analyze and create the virtual agent, wherein the visual agent is configured to be created based on the appearance of a real human character, a popular cartoon character, wherein the virtual agent is related to a personality shown in the advertisement of the area, wherein the artificial intelligence engine is configured to understand users' status from voice and language;
detecting background noise in an environment during the conversation;
analyzing levels of the background noise in the environment during the conversation;
recognizing the voice information of the user in the conversation, wherein the artificial intelligence is configured to tell the voice information of the user from the background noise by methods of voice re-identification, voice-and-face correlation, voice distance correlation, wherein voice-and-face correlation is based on model fitting of simultaneous emission of facial and vocal expressions, wherein the artificial is configured to detect whether the user is paying attention to the conversation by analyzing the facial and vocal expressions from the user;
receiving responses from the user, wherein the responses comprise voice, facial expressions, body language, motion, poses and gestures;
analyzing the user's status, wherein the user status comprises psychological status, emotion and insights;
setting a limit for a confidence level of recognition of the voice information of the user in the conversation, wherein the confidence level in real-time is decided by an interactive method, wherein the continuation of the conversation is decided by comparing the confidence level in real-time with the limit;
initiating a question to the user when the confidence level is lower than the limit;
confirming if the artificial intelligence system understands user information correctly;
apologizing to the user when the artificial intelligence cannot understand user information and asking for the user to repeat the last information from the user;
changing the confidence level to a higher value and comparing the changed confidence level to the limit;
continuing the conversation when the confidence level is higher than the limit;
using tree-based or rule-based strategy to decide responses to the responses from the user;
confirming that the user's status is aligned with the AI engine's real-time evaluation; and
checking the completion status of the set of goals in real-time, wherein if the set of goals is not reached, the AI engine is configured to continue the conversations, wherein if the set of goals is reached, the AI engine is configured to suggest to end the conversations, wherein if the user's responses are not positively driving, the AI engine is configured to revise the set of goals during the conversation by mitigating the unsatisfied responses from the user.

2. A method for providing an artificial intelligence system with ability to reduce impact from background noise within an area, the method comprising:
setting a set of goals before conversations with a user, wherein the artificial intelligence system comprises an artificial intelligence engine, wherein an artificial intelligence engine is configured to actively drive the conversations, wherein the set of goals are related to the conversations, wherein the conversations may relate to any of processes of sales, meditation, teaching, consulting, training, and mental health treatment;
detecting, by one or more processors, the user in proximity with the artificial intelligence, wherein an artificial intelligence engine in the artificial intelligence system is coupled to the one or more processors and a server, wherein the artificial intelligence engine is trained by human experts in the field, wherein a virtual agent is configured to be displayed in LED/OLED displays, Android/iOS tablets, Laptops/PCs, smartphones, or VR/AR goggles, wherein a set of multi-layer info panels coupled to the one or more processors are configured to overlay graphics on top of the virtual agent, wherein the visual agent is configured to be displayed with an appearance of a real human or a humanoid or a cartoon character, wherein the virtual agent's gender, age and ethnicity is determined by the artificial Intelligence engine's analysis on input from the user;
deciding a personality setting at the beginning of the conversation, wherein the AI engine is configured to follow the personality setting during the conversation;
initiating conversations by stating general greetings for the user if the user is a new customer or personalized greetings for the user if the user is a known customer;
asking a list of questions to the user, wherein the list of questions may be customized for the user;
confirming if the user status is ready and the user has positive emotion to continue, wherein the intelligence engine is configured to switch topics or end the conversation if the user is not ready;
detecting and tracking the user's face, eye, and pose by a set of outward-facing cameras coupled to the one or more processors, wherein a set of touch screens coupled to the one or more processors is configured to allow the user to interact with the virtual agent by hand;
using the set of outward-facing cameras to capture users' status to evaluate engagement and decide the response or trigger topics and contents of the conversations;
detecting the user's voice by a set of microphones coupled to the one or more processors, wherein the set of microphones are connected to loudspeakers, wherein the set of microphones are enabled to be beamforming, wherein pictures or voices of the user are configured to be uploaded and processed either on a cloud server or in local or personal devices to analyze and create the virtual agent, wherein the visual agent is configured to be created based on the appearance of a real human character, a popular cartoon character, wherein the virtual agent is related to a personality shown in the advertisement of the area, wherein the artificial intelligence engine is configured to understand users' status from voice and language;
detecting background noise in an environment during the conversation;
analyzing levels of the background noise in the environment during the conversation;
recognizing the voice information of the user in the conversation, wherein the artificial intelligence is configured to tell the voice information of the user from the background noise by methods of voice re-identification, voice-and-face correlation, voice distance correlation, wherein voice-and-face correlation is based on model fitting of simultaneous emission of facial and vocal expressions, wherein the artificial is configured to detect whether the user is paying attention to the conversation by analyzing the facial and vocal expressions from the user;
receiving responses from the user, wherein the responses comprise voice, facial expressions, body language, motion, poses and gestures;
analyzing the user's status, wherein the user status comprises psychological status, emotion and insights;
setting a limit for a confidence level of recognition of the voice information of the user in the conversation, wherein the confidence level in real time is decided by an interactive method, wherein the continuation of the conversation is decided by comparing the confidence level in real time with the limit;
initiating a question to the user when the confidence level is lower than the limit;
confirming if the artificial intelligence system understands user information correctly;
apologizing to the user when the artificial intelligence cannot understand user information and asking for the user to repeat the last information from the user;
changing the confidence level to a higher value and comparing the changed confidence level to the limit;
continuing the conversation when the confidence level is higher than the limit;
using tree-based or rule-based strategy to decide responses to the responses from the user;
confirming that the user's status is aligned with the AI engine's real-time evaluation; and
checking the completion status of the set of goals in real-time, wherein if the set of goals is not reached, the AI engine is configured to continue the conversations, wherein if the set of goals is reached, the AI engine is configured to suggest to end the conversations, wherein if the user's responses are not positively driving, the AI engine is configured to revise the set of goals during the conversation by mitigating the unsatisfied responses from the user.

3. A method for providing an artificial intelligence system with ability to reduce impact from background noise within an area, the method comprising:
setting a set of goals before conversations with a user, wherein the artificial intelligence system comprises an artificial intelligence engine, wherein an artificial intelligence engine is configured to actively drive the conversations, wherein the set of goals are related to the conversations, wherein the conversations may relate to any of processes of sales, meditation, teaching, consulting, training, and mental health treatment;
detecting, by one or more processors, the user in proximity with the artificial intelligence, wherein an artificial intelligence engine in the artificial intelligence system is coupled to the one or more processors and a server, wherein the artificial intelligence engine is trained by human experts in the field, wherein a virtual agent is configured to be displayed in LED/OLED displays, Android/iOS tablets, Laptops/PCs, smartphones, or VR/AR goggles;
initiating conversations by stating general greetings for the user if the user is a new customer or personalized greetings for the user if the user is a known customer;
asking a list of questions to the user, wherein the list of questions may be customized for the user;
confirming if the user status is ready and the user has positive emotion to continue, wherein the intelligence engine is configured to switch topics or end the conversation if the user is not ready;
detecting and tracking the user's face, eye, and pose by a set of outward-facing cameras coupled to the one or more processors, wherein a set of touch screens coupled to the one or more processors is configured to allow the user to interact with the virtual agent by hand;
using the set of outward-facing cameras to capture users' status to evaluate engagement and decide the response or trigger topics and contents of the conversations;
detecting the user's voice by a set of microphones coupled to the one or more processors, wherein the set of microphones are connected to loudspeakers, wherein the set of microphones are enabled to be beamforming, wherein pictures or voices of the user are configured to be uploaded and processed either on a cloud server or in local or personal devices to analyze and create the virtual agent, wherein the visual agent is configured to be created based on the appearance of a real human character, a popular cartoon character, wherein the virtual agent is related to a personality shown in the advertisement of the area, wherein the artificial intelligence engine is configured to understand users' status from voice and language;
detecting background noise in an environment during the conversation;
analyzing levels of the background noise in the environment during the conversation;
recognizing the voice information of the user in the conversation, wherein the artificial intelligence is configured to tell the voice information of the user from the background noise by methods of voice re-identification, voice-and-face correlation, voice distance correlation, wherein voice-and-face correlation is based on model fitting of simultaneous emission of facial and vocal expressions, wherein the artificial is configured to detect whether the user is paying attention to the conversation by analyzing the facial and vocal expressions from the user;
receiving responses from the user, wherein the responses comprise voice, facial expressions, body language, motion, poses and gestures;
emotion and insights;
setting a limit for a confidence level of recognition of the voice information of the user in the conversation, wherein the confidence level in real time is decided by an interactive method, wherein the continuation of the conversation is decided by comparing the confidence level in real time with the limit;
initiating a question to the user when the confidence level is lower than the limit;
confirming if the artificial intelligence system understands user information correctly;
apologizing to the user when the artificial intelligence cannot understand user information and asking for the user to repeat the last information from the user;
changing the confidence level to a higher value and comparing the changed confidence level to the limit;
continuing the conversation when the confidence level is higher than the limit;
using tree-based or rule-based strategy to decide responses to the responses from the user;
confirming that the user's status is aligned with the AI engine's real-time evaluation; and
checking the completion status of the set of goals in real-time, wherein if the set of goals is not reached, the AI engine is configured to continue the conversations, wherein if the set of goals is reached, the AI engine is configured to suggest to end the conversations, wherein if the user's responses are not positively driving, the AI engine is configured to revise the set of goals during the conversation by mitigating the unsatisfied responses from the user.
